(19) United States
(12) Patent Application Publication
(10) Pub. No.: US 2011/0112909 A1
(43) Pub. Date: May 12, 2011

(54) MULTICASTING PERSONALIZED HIGH DEFINITION VIDEO CONTENT TO CONSUMER STORAGE

(75) Inventors: Jitender SINGH, Ledgewood, NJ (US); Jose Luis DEL CERRO, Petaluma, CA (US); David BENCO, Winfield, IL (US); Ajay PANDE, St. John's (CA); Jose DE FRANCISCO LOPEZ, Aurora, IL (US)

(73) Assignee: Alcatel-Lucent USA Inc., Murray Hill, NJ (US)

(21) Appl. No.: 12/884,548

(22) Filed: Sep. 17, 2010

Related U.S. Application Data
(60) Provisional application No. 61/259,803, filed on Nov. 10, 2009.

(51) Int. Cl. G06F 15/16; G06Q 30/00

(52) U.S. Cl. 705/14.66; 709/219; 709/228

(57) ABSTRACT

Example embodiments provide methods of delivering content from a content provider to a plurality of users connected to a network. In one embodiment, an indication of available content items is received at a content management server from a content provider. An indication of the available content items is provided from the content management server to the plurality of users. The content items include at least one of programming content items and advertisement content items. A content item is selected from among the available content items for delivery. A group of users from among the plurality of users is determined to receive the selected content item. The selected content item is caused to be transmitted to the group of users via multicast streams.

### PRIORITY INFORMATION

This U.S. non-provisional patent application claims priority under 35 U.S.C. §119 of U.S. provisional patent application No. 61/259,803, filed on Nov. 10, 2009, the entire contents of which are incorporated herein by reference.

### BACKGROUND OF THE INVENTION

1. Field

The present invention relates generally to the viewing of video content and in particular to a method and apparatus for transmitting personalized high-definition video content to consumer storage devices.

2. Related Art

The public Internet continues to experience rapid growth as more people, businesses, and governments utilize it. In addition to the growth in “traditional” data traffic (file transfer, email, Web surfing, etc.) new traffic types such as voice and video are experiencing explosive growth from the likes of Skype, YouTube, Netflix, etc.

Streaming of standard-definition video content over the public Internet offers a marginal viewing experience, even on the small window of a PC. Buffering, freezing, jerky motion, and other anomalies are common. Trying to display standard definition content on a big-screen TV monitor results in a blurred, unsatisfactory viewing experience. High-definition video content poses even more problems, since the required bandwidth for high definition video is about 3 times that of standard definition video. Unfortunately, the demand for high-definition video content and HDTVs continues to increase. Furthermore, industry analysts report that consumers much prefer network access to video content rather than physical media (DVDs, etc.) which are easily lost or damaged. Consumer behavior has changed such that personal collections of physical media (“purchase to own”) are transitioning to a “purchase to view” model. Companies like Blockbuster and Netflix are aggressively seeking to establish themselves to offer content via the Internet vs. by retail outlet or postal mail. Walt Disney Co. is market trialing a new service called Keychest which would render physical media obsolete. Other content producers are actively promoting DECE (Digital Entertainment Content Ecosystem), a similar system.

The technical problem at hand, therefore, is to design a solution which allows consumers to experience a satisfactory viewing experience of Internet video (such as catch-up TV, movies, education/training videos, etc.) in high-definition on a large screen TV monitor, without resorting to physical media.

Existing solutions (such as IPTV) rely upon an end-to-end managed network in order to guarantee the quality of service necessary to stream high definition video to a consumer's HDTV. This solution has a number of disadvantages: 1) it is very expensive and time consuming to build out the infrastructure to support such a service, 2) all such services are not available in all geographic areas, 3) consumers are restricted to the content offered by their TV provider (IPTV, cable TV, etc.). Also, “over the top” (OTT) content (such as Netflix movies, YouTube videos, catch-up TV, etc.) utilizes the Internet Service Provider's (ISP) network without any compensation to the ISP.

Other expensive solutions such as conventional Content Delivery Systems (CDNs) cache content in hundreds or thousands of locations within the Internet and stream that content to individual consumers. Although this removes some network bottlenecks, there is not a guaranteed level of viewing experience for the consumer.

### SUMMARY OF THE INVENTION

One or more embodiments relate to a method of providing multimedia content to a plurality of users via multicast streams.

In one embodiment, a method for facilitating delivery of content from a content provider to a plurality of users connected to a network includes receiving, at a content management server connected to the network, an indication of available content items from a content provider. An indication of the available content items is provided from the content management server to the plurality of users. The content items include at least one of programming content items and advertisement content items. A content item is selected from among the available content items for delivery, a group of users, from among the plurality of users, is determined to receive the selected content item, and the content management server causes the selected content item to be transmitted to the group of users via multicast streams.

Causing the selected content to be transmitted to the group of users via multicast streams may include receiving address information associated with the selected content item from the content provider, sending the address information and an indication of the determined group of users to a transmission server, and instructing the transmission server to establish a multicast session including the users in the determined group of users, and to transmit the selected content to the users in the determined group via multicast streams.

The method may further include generating content recommendations for the plurality of users where each content recommendation identifies, for a user corresponding to the content recommendation, one or more items of content from among the available items of content as recommended content.

The method may further include receiving content requests from the plurality of users where each content request identifies, for a user corresponding to the content request, an item of content from among the available items of content the user desires to receive.

Selecting the content item for delivery may include prioritizing the available items of content based on at least one of the generated content recommendations and the received content requests, and selecting the item of content having the highest priority for delivery.

If the selected content item is a programming item, determining the group of users to receive the selected content may include analyzing the generated content recommendations and the received content requests, and choosing, as members of the group, users corresponding to either a content recommendation or a content request that identifies the selected programming content item.

Each of the content recommendations may be generated based on at least one of demographic or preference information associated with the user corresponding to the content recommendation.

If the selected content item is an advertisement item, determining the group of users to receive the selected content may include analyzing the received content requests, and choosing, as members of the group, users corresponding to a content request that identifies the selected advertising content item.

Each of the content recommendations may be generated based on at least one of demographic or preference information associated the user corresponding to the content recommendation.

The content requests may be stored as playlists at the content management server which provides users with access to playlists via a web GUI interface.

In another example embodiment, a method of transmitting content to a plurality of users connected to a network using multicast technology includes receiving, at a transmission server connected to the network, a content item, and receiving at the transmission server information identifying a group of users, from among the plurality of users, to whom the item of content is to be delivered. A multicast session is formed for the group of users, and the item of content is be transmitted from the transmission server to the group of users using multicast streams. A user, from among the group of users, that lost a connection to the multicast session before the transmission of the item of content is completed is detected and the item of content is be transmitted to the detected user using a unicast stream.

Receiving the content item may include storing the content item in a storage unit, and transmitting the item of content to the detected user may include retrieving the stored contend item from the storage unit.

The stored content item may be retrieved from the storage unit and sent to the detected user via the unicast stream by a retransmission server.

According to yet another example embodiment, a method of displaying advertising content received at a client unit from a content distribution service to a user of the client unit includes receiving and storing, at the client unit, programming content from a transmission server via a multicast stream. The programming content includes metadata that represents at least one insertion point within the programming content. Advertising content from the transmission server is received via a multicast stream and stored at the client unit. The advertising content has a subject matter associated with preferences of the user. The programming content is displayed to the user until the at least one insertion point indicated by the metadata is reached. Display of the programming content is suspended and the advertising content is displayed once the at least one insertion point is reached. Display of the programming content is resumed once the displaying of the advertising content is complete.

### BRIEF DESCRIPTION OF THE DRAWINGS

Example embodiments of the present invention will become more fully understood from the detailed description provided below and the accompanying drawings, wherein like elements are represented by like reference numerals, which are given by way of illustration only and thus are not limiting of the present invention and wherein:

FIG. 1 illustrates a portion of a data network.

FIG. 2 is flow chart illustrating a method for facilitating delivery of content from a content provider to a plurality of users connected to a network.

FIG. 3 is a flow chart illustrating a method of transmitting multimedia content to a plurality of users connected to a network using multicast technology.

FIG. 4 illustrates a method of displaying advertising content received at a client unit from a content distribution service to a user of the client unit.

### DETAILED DESCRIPTION OF EXAMPLE EMBODIMENTS

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Exemplary embodiments are discussed herein as being implemented in a suitable computing environment. Although not required, exemplary embodiments will be described in the general context of computer-executable instructions, such as sections, program modules or functional processes, being executed by one or more computer processors or CPUs. Generally, sections, program modules or functional processes include routines, programs, objects, components, data structures, etc. that performs particular tasks or implement particular abstract data types. The sections, program modules and functional processes discussed herein may be implemented using existing hardware in existing communication networks. For example, sections, program modules and functional processes discussed herein may be implemented using existing hardware at existing network elements, servers or control nodes. Such existing hardware may include one or more digital signal processors (DSPs), application-specific-integrated-circuits, field programmable gate arrays (FPGAs) computers or the like.

In the following description, illustrative embodiments will be described with reference to acts and symbolic representations of operations (e.g., in the form of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

### Overview

In accordance with various illustrative embodiments of the present invention, multicasting protocols are advantageously used to transmit high-definition video content to consumer storage devices (e.g., a PC hard drive, Digital Video Recorder, etc.). This offers a number of advantages: 1) reduced network traffic, as thousands of individual video streams are replaced by a handful of multicast sessions, 2) a guaranteed high quality viewing experience for high-definition video content, since the content would reside on a device in the consumer's home, 3) a convenient way for consumers to view high-definition “off-deck” content, that is, content not offered by their cable TV or IPTV provider, 4) a way for ISPs to monetize the use of their network resources, by offering content providers access to a mechanism to deliver high-definition video content directly to consumers.

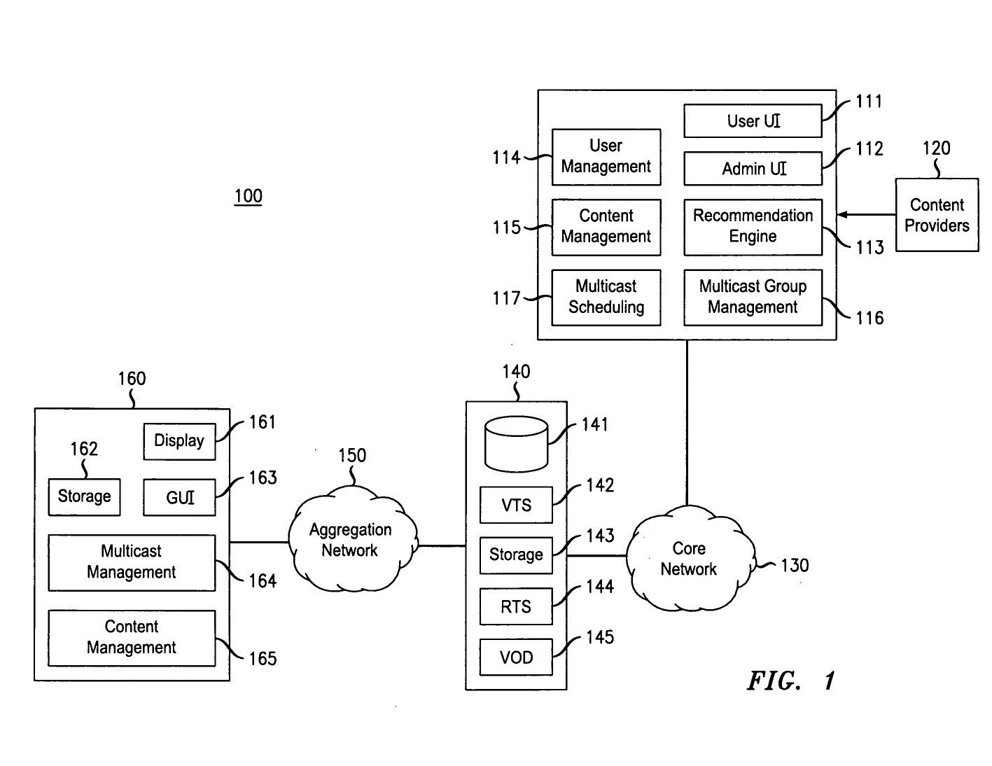

Example embodiments of an architecture for a network implementing a content delivery system according to embodiments of the present invention will now be discussed below with reference to FIG. 1.

FIG. 1 illustrates a portion of a data network 100. Data network 100 is capable of supporting a content delivery service through which multimedia content is delivered from content providers to users using multicasting. Data network 100 includes a content management server (CMS) 110, a core network 130, a network interface 140, an aggregation network 150 and a client unit 160.

Example embodiments of a content delivery system according to embodiments of the present invention will now be discussed in greater detail below with reference to 3 portions of the content delivery system, 1) the CMS 110; 2) a video transmission server (VTS) 142 and a retransmission server (RTS) 144 in the network interface 140; and 3) the client unit 160.

### The CMS

The CMS 110 may implement the content delivery service according to example embodiments of the present invention and is operated by, for example, a service operator. The service operator may be associated with, for example, a data/telecommunications provider. The CMS 110 receives requests and preferences from users regarding content offered by the content provider 120, and facilitates the reliable delivery of the content to the users while working with the VTS 142, RTS 144 and client unit 160 to significantly minimize both the service operator's burdens of storing the multimedia content and handling the data traffic on the service operator's network as will be discussed in greater detail below.

The CMS 110 is capable of receiving multimedia content from the content provider 120, and managing the forwarding of the multimedia content to users of the content delivery service. Users of the content delivery service according to embodiments of the present invention each receive the multimedia content at corresponding client units, for example client unit 160, via the core network 130, the network interface 140, and the aggregation network 150, each of which will be discussed in greater detail below.

The content provider may be any entity that has multimedia content to offer. Examples of the content provider 120 include television broadcast networks, movie providers and advertisers. The multimedia content provided by the content provider 120 may include programming content and advertising content. Programming content may include, for example, TV shows, movies, music videos, etc. The content provided by content provider 120 may include standard definition content as well as high definition (HD) content.

The content provider 120 may provide content and other information necessary for managing the content to the CMS 110 using, for example an online video platform capable of interfacing with the content management system platform used to implement the CMS 110. Examples of interfacing system configurations for the content provider 120 and the CMS 110 include the online video platform, Kaltura, and the content management system platform, Drupal.

Though, for the purpose of simplicity, data network 100 is illustrated as including only one content provider, the content provider 120, interfacing with the CMS 110, the CMS 110 may include interfaces for any number of content providers.

The CMS 110 includes a user UI section 111 for providing users of the content delivery service with access to the CMS 110. For example, the user UI section 111 is capable of providing a web based online user interface through which users of the content delivery service can browse various multimedia content available at the CMS 110. The online user interface also allows users to select multimedia content the users wish to receive by, for example, creating playlists of content which are stored at the CMS 110.

For example, the online user interface can be provided in the form of a web page which may include an area for playlist management and an area for searching for particular content. For example, the play list management may include a drag-and-drop function which will allow a user to select programming content and place the programming content into a playlist created by the user. A playlist created by a user may be treated as a queue. For example, a user may be able to indicate a priority level of an item of programming content within a playlist by dragging that item to a particular position within the playlist. The online user interface may also include an area indicating content that has already been downloaded and is available to be viewed immediately by a user.

The online user interface may also allow users to submit personal preferences relating to programming content. For example, a user can use the online user interface provided by the use UI section 111 to provide user preference information indicating in which of a variety of programming content types the user is interested. Examples of programming content types include sports, dramas, comedies, action, science fiction, automobiles, nature, politics, etc. Further, the online user interface may allow users to submit a user ratings associated with a particular item of multimedia content. A user rating may be an indication of how much a user likes or dislikes a particular item of multimedia content. Information provided by users using the user UI section 111 may be stored in the user management section 114 of the CMS 110. The user management section 114 will be discussed in greater detail below.

The CMS 110 includes an administrator UI section 112 for providing system administrators with access to the CMS 110. For example, the administrator UI section 112 is capable of providing a web based online administrator interface through which administrators of the content delivery service can manage the content delivery service. The online administrator interface may be provided in the form of a web page. Through the administrator UI section 112, administrators can, for example, manage user information, review and analyze user statistics, and manage content available at the CMS 110.

The CMS 110 includes a user management section 114 which stores user-related information for each user. The user-related information stored in the user management section 114 for each user may include, for example, profile information and viewing history, as well as the user ratings and user playlists discussed above with reference to the UI section 111. The profile information may include demographic information relating to a user including, for example, gender, age, occupation, education level, geographical location, etc. The profile information may also include user preference information provided by a user as is discussed above with reference to the user UI section 111. The viewing history may include, for example, a log of multimedia content selected by a particular user. The user-related information stored for each user may also include programming and advertisement content recommendations provided by the recommendation engine 113. Content recommendations provided by the recommendation engine 113 will be discussed in greater detail below.

The CMS 110 includes a recommendation engine 113. The recommendation engine 113 is capable of forming recommendations regarding programming and advertising content to send to a user based on, for example, the user demographic and preference information stored in the user management section 114. Once the recommendation engine 113 determines a particular item of programming or advertisement content to recommend to a user of the content delivery system, the recommendation engine 113 can provide the programming or advertisement content recommendations to user management section 114 which stores the recommendation with the user-related information associated with the user for which the recommendation is provided.

With respect to programming content recommendations, once the user management section 114 stores a programming content recommendation received from the recommendation engine 113, an indication of the recommended programming content appears within the online user interface provided to the user by the user UI section 111 as recommended content. For example, a visual indicator associated with the content recommendations generated by the recommendation engine 113 can appear alongside a user's playlist within the online user interface in order to facilitate the process of placing recommended items into a user's playlist.

The CMS 110 includes a content management section 115 for managing multimedia content received from the content provider 120. The content management section 115 may include storage for storing content received from the content provider 120. The content management section 115 may also store or address information, received from the content provider 120, associated with content stored at the content provider 120. The content management section 115 is capable organizing the multimedia content into a plurality of channels according to, for example, provider and/or subject matter type in order to facilitate the browsing function provided by the user UI section 111 as discussed above.

The CMS 110 includes a multicast group management section 116. The multicast group management section 116 is capable of organizing users of the content delivery system into multicast groups for receiving a particular item of multimedia content. The multicast groups generated by the group management section 116 are used to deliver the multimedia content to the users of the content delivery system via multicast streams. The multicast group management section is capable of creating programming groups and an advertisement groups. Programming groups are multicast groups used to deliver non-advertisement multimedia content to users of the content delivery service. Advertisement groups are multicast groups used to deliver advertisements to users of the content delivery service.

The multicast group management section 116 is capable of forming programming and advertisement groups based on current content needs of users. For example, once the CMS 110 selects a particular piece of programming or advertisement content to send to users, the multicast group management section 116 determines which users are to receive the selected content and forms one or more multicast groups including those users. The multicast group management section 116 determines which users to send the content to based on user-related information stored in the user management section 114.

If the selected content is programming content, the multicast group management section 116 chooses users based on the playlist entries and programming recommendations associated with the user in the user management section 114.

If the selected content is advertisement content, the multicast group management section 116 chooses users based on advertisement recommendations associated with the user in the user management section 114.

The multicast group management section 116 is capable of further dividing the chosen users into groups based one or more criteria that may affect download speed including, for example, the definition level of the content requested by each user, i.e. standard or high, as well as the Internet service bandwidth available to each user. High definition programming includes more data than standard definition programming. Accordingly, by dividing users chosen to receive the selected content into multiple multicast groups based on the size of the selected content, and/or the download speed available to each of the chosen users, the multicast group management section 116 can optimize usage of the available network bandwidth for each group of users.

The multicast group management section 116 is capable of forming groups dynamically each time the CMS 110 selects a particular piece of programming of advertisement content to send. Accordingly, the lifespan of a multicast group created by the multicast group management section 116 for a selected piece of content may end once the selected content has been sent to the users in the multicast group.

The CMS 110 includes a multicast scheduling section 117. The multicast scheduling section 117 is capable of determining a schedule for delivering advertisements to users within advertisement multicast groups, and determining a schedule for delivering programs to users within program multicast groups via multicast sessions. Scheduling of multicast sessions may be accomplished using any of a number of factors. The multicast scheduling section 117 may schedule multicast session according to a particular time of day. For example, the multicast scheduling section 117 may schedule content to be delivered every day at 1 AM. The multicast scheduling section 117 may schedule multicast session according to network loading conditions. For example, the multicast scheduling section 117 may determine to deliver content when an average latency experienced by users of one or more multicast groups falls below a particular threshold. The multicast scheduling section 117 may schedule multicast session according to end-device conditions. For example, the multicast scheduling section 117 may schedule content to be delivered to all members of a multicast group who have available storage space which exceeds a threshold, for example 20 GB. The multicast scheduling section 117 may also schedule multicast session according to a specific refresh period. For example, the multicast scheduling section 117 may schedule content to be pushed to users according to a 5 day refresh period such that every 5 days, new content is sent to a user's storage, and older content is deleted unless the older content been identified by a users as content which is not to be deleted.

The multicast scheduling section 117 is also capable of prioritizing items of multimedia content for delivery. For example, the multicast scheduling section 117 may prioritize programming content according to popularity. The multicast scheduling section can choose to transmit the items of content that appear the most in the playlists and content recommendations of the users before other items of content. Further, the multicast scheduling section may prioritize advertisements over programming content.

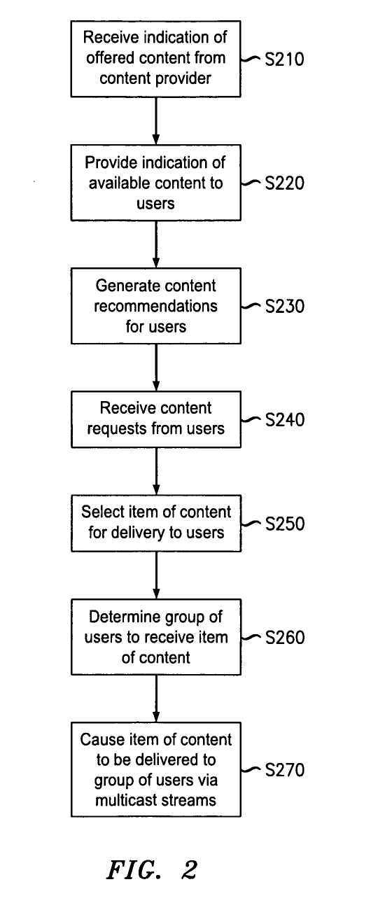

An example operation of the CMS 110 will now be discussed with reference to claim FIG. 2. FIG. 2 is a flow chart illustrating a method for facilitating delivery of content from a content provider to a plurality of users connected to a network.

Referencing FIG. 2, in step S210, the CMS 110 receives an indication of offered content from the content provider 120. For example, the CMS 110 can access information regarding programming offered by the content providers through the interface between an online video platform used by the content provider 120 and a content management system platform used to implement the CMS 110.

In step S220, the CMS 110 provides an indication of available content to users of the content delivery system. For example, as is discussed above, the user UI section 111 of the CMS 110 may provide a listing of the programming offered by the content provider 120 to users through the online user interface. The CMS 110 is capable of continuously updating the listing of programming as the programming offered by the content provider 120 changes.

In step S230, the CMS 110 may generate content recommendations. For example, as is discussed above, the recommendation engine 113 may analyze the offered content obtained by the CMS 110 in step S210 and generate content recommendations that recommend individual items of content within the offered content to users based on the demographic and/or preference information stored within the user management section 114. The generated content recommendations include recommendations for programming content and advertising content.

In step S240, the CMS 110 receives content requests from users. For example, as is discussed above, users may use the online user interface provided by the user UI 111 to place specific items of programming content offered by the content provider 120 into a playlist indicating to the CMS 10 that the user wishes to receive that item of content.

In step S250, the CMS 110 selects an item of content for delivery. For example the multicast scheduling section 117 may choose an offered item of content having a highest priority value to send to the users. The multicast scheduling section may determine priority values for the items of offered content based on a number of factors including, how often each item has been recommended by the recommendation engine 113, whether the item is a programming item or an advertising item, and, in the case of programming items, how often each programming item has been placed in a playlist by a user.

In step S260, the CMS 110 determines a group of users to receive the item of content selected in step S250. For example, as is discussed above, the multicast group management section 116 may access information stored for each user in the user management section 114, and identify which users are to receive the selected item by finding users having content recommendations or, in the case of programming content, playlist entries corresponding to the item of content selected in step S250. The multicast group management section 116 may then form a group including the identified users. As is discussed above, the multicast group management section may further divide the identified users and assign the users to multiple sub groups based on factors including whether the user is receiving HD or standard content, and an internet service bandwidth associated with the user.

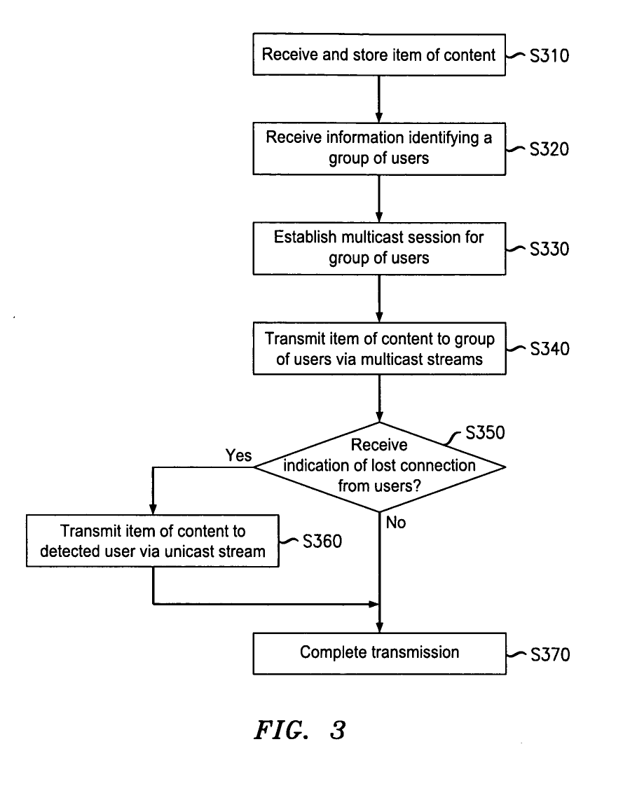

In step S270, the CMS 110 causes the item of content to be delivered to the group or groups of users determined by the multicast group management section 116. For example, the CMS 110 may forward information identifying the group or groups of users that are to receive the selected item of content to the VTS 142. The information may include network addresses of the users. The CMS may also acquire address information, for example a link, associated with the selected item of content from the content provider 120 and forward the address information to the VTS 142 along with instructions to obtain the item of content from the content provider 120, form one or more multicast sessions corresponding to the one or more groups determined by the multicast group management section 116, and to deliver the item of content to the users in the one or more groups via multicast streams. As an alternative to obtaining and forwarding address information associated with the selected item of content, the CMS 110 may also obtain the actual selected item of content itself from the content provider 120, and forward the selected item of content to the VTS 142. The operation of the VTS 142 will be discussed in greater detail below with reference to FIG. 3

Accordingly, using the method discussed above with reference to FIG. 2, the CMS 110 is capable of facilitating the distribution of multimedia content provided by one or more content providers to users of the content delivery system. The CMS 110 can choose which content to provide to the users based on at least one recommendation generated by the CMS or specific requests from the client. Accordingly, the CMS 110 provides users with access to content which is likely to satisfy the desires of the users. Further, in order to send an item of content, the CMS 110 does not need to send a number of streams through the core network 130 that is based on the number of users receiving the content. Instead, the CMS 110 can cause an item of content to be delivered to, for example, thousands of users by causing only a handful of multicast streams to be sent through the core network 130, where the handful of streams correspond to, for example, different definition levels of content (i.e., a stream for standard definition and a stream for HD) or multiple VTSs as will be discussed in greater detail below.

### The VTS and RTS

The video transmission server (VTS) 142 and retransmission server (RTS) 144 work together to minimize the amount of traffic traveling over the core network 130 by facilitating the delivery of content to, for example, thousands of users using multicast streams while requiring only, for example, a few streams to pass through the core network 130 from the CMS 110 or content provider 120 to the VTS 142. The VTS 142 and RTS 144 will now be discussed in greater detail below.

The VTS 142 is capable of establishing multicast sessions for content that is selected to be sent by the CMS 110, and delivering the content to client units of the users via multicast streams. The VTS 142 establishes the multicast sessions based on the multicast groups determined by the CMS 110 and delivers the content to the client units of the users according to the schedule determined by the CMS 110. Further, the VTS 142 is capable of providing viewing statistics to the CMS 110 for users associated with the VTS 142. The VTS 142 is also capable of temporarily storing content that is being delivered in storage unit 143.

The RTS 144 is capable of forming unicast streams for content stored in the storage 143 for users who experience interruptions during a multicast session. For example, if one or more users in a multicast group receiving multicast streams of selected content from the VTS 142 lose a connection to the VTS 142, the RTS 144 detects a point in the content where the user experienced lost the connection, and provides the remaining portion of the content to the user using a unicast stream.

The VTS 142 and RTS 144 are located within the network interface 140 which provides an interface between the aggregation network 150 and the core network 130 and may be, for example, a central office. The core network 130, network interface 140 and aggregation network 150 will now be discussed in greater detail below

The core network 130 is a main network which may be, for example, associated with or owned and operated by, the service operator of the content delivery system according to embodiments of the present invention. The core network 130 may be, for example, a nation-wide network. The core network 130 connected to the aggregation network 150. The aggregation network 150 is a regional network and is associated with the network interface 140. Though the data network 100 is illustrated as including only one aggregation network, the data network may include any number of aggregation networks each of which is associated with a geographical region and a corresponding network interface.

In addition to the VTS 142 and RTS 144, the network interface 140 may include a super point-of-presence (POP) 141, storage 143, and a video-on-demand (VOD) server 145.

The super POP 141 provides a high bandwidth interface between the core network 130 and the aggregation network 150.

The VOD server 145 supports general VOD services for users subscribing to the content delivery service implemented by the CMS 110.

Though, in FIG. 1 only one VTS, RTS and VOD server are illustrated as being associated with the aggregation network 150. Each aggregation network in the data network 100 can include any number of VTSs, RTSs and VOD servers according to the number of users in the geographical region associated with the aggregation network. Further, though the VTS 142, RTS 144, and VOD server 145, are illustrated as separate devices two or more of the VTS 142, RTS 144, and VOD server 145 can be implemented as one or two server devices each of which may or may not incorporate the storage unit 143.

FIG. 3 illustrates an example operation of the VTS 142 and the RTS 144 providing an item of content to users will now be explained with reference to FIG. 3. FIG. 3 is a flow chart illustrating a method of transmitting multimedia content to a plurality of users connected to a network using multicast technology.

Referring to FIG. 3, in step S310 an item of content is received and stored. For example, the VTS 142 may receive an item of content selected for delivery by the CMS 110. For example, the VTS 142 may send a request to the CMS 110 for link or other address information associated with the selected content. The VTS 142 may then receive the link or other address information regarding the item of content from the CMS 110, and the VTS 142 may use the address information to request the item of content from the content provider 120 and receive the item of content via one or more unicast streams from the content provider 120. Alternatively, the VTS 142 may receive the item of content via one or more unicast streams received from the CMS 110. As the item of content is received by the VTS 142, the VTS 142 may store the item in the storage unit 143.

In step S320, information identifying a group of users who are to receive the item of content received in step S310 is received. For example, the VTS 142 may receive from the CMS 110 information identifying addresses of each of users who are to receive the item of content as well as information regarding one or more groups into which the users have been assigned.

In step S330 one or more multicast sessions for the one or more groups of users identified in the information received in step S320 are established. For example, the VTS 142 may establish a multicast session corresponding to each of the one or more identified groups of users. For example, the VTS 142 may generate one or more multicast addresses corresponding to each multicast session, and forward corresponding multicast addresses to client units corresponding to each user in each group along with an indication to join the corresponding multicast session. The VTS 142 may use any known multicast protocol including, for example, (internet group management protocol) IGMP.

In step S340, the item of content received in step S310 is transmitted to the one or more groups of users identified by the information received in step S320. For example, the VTS 142 may transmit the item of content to one or more multicast addresses corresponding to the one or more groups of users.

In step S350, it is determined whether an indication of a lost connection has been received by the RTS 144. For example, if client unit of a user loses a connection to the VTS 142, the client unit may send a message to the RTS 144 notifying the RTS 144 of the lost connection. The message may include, for example, an address of the user that lost the connection as well as an indication of a time point within the transmission of the item of content where the connection was lost. The RTS 144 may receive a lost connection indication at any point during transmission of an item of content by the VTS 142 to users.

If, in step S350 the RTS 144 determines that no lost connection indications have been received, the method proceeds to step S370, and transmission of the item of content being delivered is completed.

If, in step S350 the RTS 144 determines that a lost connection indication has been received the method proceeds to step S360.

In step S360, the item of content is transmitted to users detected in step S350 via unicast streams. For example, the RTS 144 may receive addresses information from the lost connection indications received in step S350 as well as an indication of a time point within the content being delivered where each user lost their connection. Next, the RTS 144 may transmit the item of content being delivered to the each of the one or more users who sent lost connection indications starting at a time point in the item of content where each of the one or more users lost their connection. The RTS 144 may obtain the item of content being delivered by accessing the storage unit 143 which stores the item of content being delivered. Once the item of content has been transmitted to the one or more users detected in step S350 as having lost their connections is complete, the method proceeds to step S370 and transmission of the item of content is completed.

Accordingly, using the method described above with reference to FIG. 3, the VTS 142 and RTS 144 work together with the CMS 110 to provide content to users reliably while minimizing an amount of traffic sent over the core network 130. Further, when a user loses a connection to a multicast session, instead interrupting and restarting a multicast session for all members of a multicast group when one member loses a connection, the disconnected user can resume viewing the content via a unicast stream from the RTS 144, and the remaining members of the multicast group can continue receiving the content without interruption.

### The Client Unit

Client units, including, for example, the client unit 160, provide users with the ability to communicate with the CMS 110 and to receive multimedia content offered by the content provider 120 using the CMS 110. Client units also serve as the primary storage point for multimedia content provided by the content provider 120 to the users of the content delivery system according to embodiments of the present invention. Accordingly, client units, which may be owned and maintained by the users, save the operator of the content delivery service resources by preventing the operator from having to provide, for example, a number of network servers or caches on the core network 130 for the purpose of storing the multimedia content viewed by the users. Client units will now be discussed in greater detail below with reference to the client unit 160 illustrated in FIG. 1.

The client unit 160 may be implemented by a device designed to operate with the CMS 110. Further, the client unit 160 is not necessarily an integral unit and may include multiple devices which work together to provide a user with access to CMS 110 and the multimedia content provided by the content provider 120 through the CMS 110.

The client unit 160 includes a display unit 161, a storage unit 162, a graphical user interface (GUI) 163, a multicast management section 164, and a content management section 165.

The display unit 161 may be any type of display device which allows a user of the client unit 160 to view multimedia content. Examples of the display unit 161 include a laptop screen, a computer monitor, a television, a smart phone, a PDA, a portable gaming device, etc. Further, the display unit 161 may be implemented by multiple display devices.

The GUI 163 is any device which allows the user to access the online user interface provided by the CMS 110. Accordingly, examples of the GUI 163 include a laptop or desktop computer, an internet-enabled television, a smart phone, a PDA, a portable gaming device, a touch-screen remote device, etc. Further, the GUI 163 and the display unit 161 may be part of the same device. Through the GUI 163 the user can access any of the functions provided by the online user interface discussed above including, for example, viewing content offered by content providers, creating or editing playlists, entering demographic information, or providing preference information, for example, in the form of ratings or reviews for items of multimedia content.

The storage 162 holds the multimedia content received by the client unit 160. The storage unit may be implemented by any device or devices capable of storing multimedia content. Examples of the storage unit 162 include a laptop or desktop hard drive, an external hard drive, a network accessible hard drive, a gaming console, etc.

The multicast management section 164 is capable of allowing the client unit 160 to participate in multicast sessions established by the VTS 142, and to receive multimedia content from the VTS 142 via multicast streams. The multicast management section is capable of performing operations necessary to join or leave multicasts sessions established by the VTS 142. The multicast management section 164 is also capable of notifying the RTS 144 if the CMS 110 loses a connection to a multicast session established by the VTS 142 prior to completing receipt of an item of content being sent by the VTS 142 to the client unit 160.

The content management section 165 is capable of managing the multimedia content received by the client unit 160. The content management section 165 is also capable of tracking viewing statistics and, periodically, providing the viewing statistics to the CMS 110 via the VTS 142.

The content management section 165 is also capable of performing dynamic ad insertion by suspending playback of programming content at specific points indicated by metadata within the programming content, and causing advertising content which has been downloaded to the client unit 160 to be displayed.

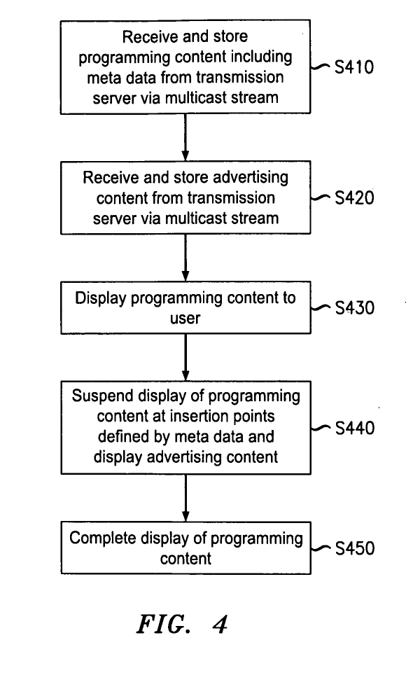

An example operation of the client unit 160 will now be discussed with reference to FIG. 4. FIG. 4 illustrates a method of displaying advertising content received at a client unit from a content distribution service according to example embodiments of the present invention to a user of the client unit.

Referencing FIG. 4, in step S410 an item of programming content is received. For example, the client 160 may receive an item of programming content from the VTS 142 via a multicast stream. While receiving the item of programming via the multicast stream, if the multicast management section 164 detects an interruption in the connection between the client 160 to the VTS 142, the multicast management section may notify the RTS 144 of the lost connection. The client 160 may then receive the remaining portion of the programming content from the RTS 144, via a unicast stream.

The client 160 stores the received item of programming content in the storage unit 162. The item of programming content may be, for example, a TV show or a movie. The item of programming content includes metadata which specifies insertion points within the programming content for advertising content.

In step S420, an item of advertising content is received. For example, the client 160 may receive an item of advertising content from the VTS 142, via a multicast stream. While receiving the item of advertising content via a multicast stream, if the multicast management section 164 detects an interruption in the connection between the client 160 to the VTS 142, the multicast management section may notify the RTS 144 of the lost connection. The client 160 may then receive the remaining portion of the advertising content from the RTS 144 via a unicast stream. The client 160 stores the received item of advertising content in the storage unit 162.

The item of advertising content may be, for example, a commercial. The advertising content may be content selected by the CMS 110 based on a recommendation provided for the user of the client unit 160 by the recommendation engine 130. Accordingly, the subject matter of the advertising content may be related to at least one of demographic information or subject matter preferences associated with the user of the client unit 160.

In step S430, the programming content is displayed to the user. For example, the user may use the GUI 163 to browse the programming content stored in the storage unit 162, and select an item of programming content to view. The content management section 165 may access the selected item of programming content in the storage unit 162, and cause the selected item of programming content to be displayed using the display unit 161.

With respect to steps S420 and S430, playback of the programming and advertising content may commence after receipt of the content is completed.

In step S440, playback of the item of programming content is suspended at insertion points defined by the metadata in the programming content, and the stored advertising content is played. For example, during playback of the programming content, the content management section 165 may analyze the metadata included in the programming content and detect insertion points in the programming content indicated by the metadata.

At the insertion points, the content management section 165 may cause playback of the item of programming content to be suspended, and may cause playback of one or more items of advertising content stored in the storage unit 163. An item of programming content may include multiple insertion points. In addition to specifying a time point within an item of programming content for each insertion point, the metadata included in the item of content may specify other information regarding each insertion point including, for example, a maximum length of time for the programming content to be suspended for each insertion point.

In step S450, display of the programming content is completed. After each insertion point in the item of programming content is passed, the client unit 160 continues playback of the item of programming content continues until completion.

Accordingly, using the method described above with reference to FIG. 4, the client units in data network 100 can receive multimedia content of interest to the user of the client units and provide high quality playback of the received content. Further, because the multimedia content may be fully transmitted and stored at the client units before being viewed by a user, the user can view even data heavy, HD content with a high level of quality without experiencing the types of interruptions commonly associated with video that is viewed while being streamed over the internet.

Additionally, the client unit 160 is capable of inserting highly-relevant advertisements during playback of the programming content. Accordingly, the client unit provides advertisers with the opportunity to increase returns as a result of better targeting of the ads.

The invention being thus described, it will be obvious that the same may be varied in many ways. Such variations are not to be regarded as a departure from the invention, and all such modifications are intended to be included within the scope of the invention.

1. A method for facilitating delivery of content from a content provider to a plurality of users connected to a network, the method comprising:
receiving, at a content management server connected to the network, an indication of available content items from a content provider;
providing an indication of the available content items from the content management server to the plurality of users, the content items including at least one of programming content items and advertisement content items;
selecting a content item from among the available content items for delivery;
determining a group of users from among the plurality of users to receive the selected content item;
causing the selected content item to be transmitted to the group of users via multicast streams.

2. The method claim 1, wherein causing the selected content to be transmitted to the group of users via multicast streams includes:
receiving location information associated with the selected content item from the content provider;
sending the location information and an indication of the determined group of users to a transmission server; and
instructing the transmission server to establish a multicast session including the users in the determined group of users, and to transmit the selected content to the users in the determined group via multicast streams.

3. The method of claim 1, further comprising:
generating content recommendations for the plurality of users, each content recommendation identifying, for a user corresponding to the content recommendation, one or more items of content from among the available items of content as recommended content.

4. The method of claim 3, further comprising:
receiving content requests from the plurality of users, each content request identifying, for a user corresponding to the content request, an item of content from among the available items of content the user desires to receive.

5. The method of claim 4, wherein selecting the content item for delivery includes, prioritizing the available items of content based on at least one of the generated content recommendations and the received content requests, and selecting the item of content having the highest priority for delivery.

6. The method of claim 4, wherein if the selected content item is a programming item, determining the group of users to receive the selected content includes analyzing the generated content recommendations and the received content requests, and choosing, as members of the group, users corresponding to either a content recommendation or a content request that identifies the selected programming content item.

7. The method of claim 6, wherein each of the content recommendations are generated based on at least one of demographic or preference information associated with the user corresponding to the content recommendation.

8. The method of claim 4, wherein if the selected content item is an advertisement item, determining the group of users to receive the selected content includes analyzing the received content requests, and choosing, as members of the group, users corresponding to a content request that identifies the selected advertising content item.

9. The method of claim 8, wherein each of the content recommendations are generated based on at least one of demographic or preference information associated the user corresponding to the content recommendation.

10. The method of claim 4, wherein content requests are stored as playlists at the content management server which provides users with access to playlists via a web GUI interface.

11. A method of transmitting content to a plurality of users connected to a network using multicast technology, the method comprising
receiving, at a transmission server connected to the network, a content item;
receiving at the transmission server information identifying a group of users, from among the plurality of users, to whom the item of content is to be delivered;
establishing a multicast session for the group of users;
transmitting the item of content from the transmission server to the group of users using multicast streams;
detecting a user from among the group of users that lost a connection to the multicast session before the transmission of the item of content is completed; and
transmitting the item of content to the detected user using a unicast stream.

12. The method of claim 11, wherein receiving the content item includes storing the content item in a storage unit, and transmitting the item of content to the detected user includes retrieving the stored contend item from the storage unit.

13. The method of claim 12, wherein the stored content item is retrieved from the storage unit and sent to the detected user via the unicast stream by a retransmission server.

14. A method of displaying advertising content received at a client unit from a content distribution service to a user of the client unit, the method comprising:
receiving and storing, at the client unit, programming content from a transmission server via a multicast stream, the programming content including metadata representing at least one insertion point within the programming content;
receiving and storing, at the client unit, advertising content from the transmission server via a multicast stream, the advertising content having a subject matter associated with preferences of the user;
displaying the programming content to the user until the at least one insertion point indicated by the metadata is reached;
suspending display of the programming content and displaying the advertising content once the at least one insertion point is reached; and
resuming display of the programming content once the displaying of the advertising content is complete.
